(19) United States
(12) Patent Application Publication
(10) Pub. No.: US 2017/0316483 A1
(43) Pub. Date: Nov. 2, 2017

(54) GENERATING A PERSONALIZED LIST OF ITEMS

(71) Applicant: eBay Inc., San Jose, CA (US)

(72) Inventors: Geoff Lester, Oakland, CA (US); Mats Nilsson, Kentfield, CA (US)

(21) Appl. No.: 15/143,042

(22) Filed: Apr. 29, 2016

(51) Int. Cl. G06Q 30/06; G06F 17/30

(52) U.S. Cl. CPC G06Q 30/0625; G06F 17/30867; G06Q 30/0641

(57) ABSTRACT

A method to generate a personalized list of items is disclosed. The method may include receiving a search request for an event from a user via a user device. The method may also include determining a set of items pertaining to the event based on the search request. The method may further include determining an item score for each item in the set of items based at least in part on user information and a plurality of properties. The method may include generating a personalized item listing that includes at least some of the items in the set of items based on the item score of each item. The method also may include transmitting the personalized list of items to the user device for display on the user device.

### FIELD

The embodiments discussed in the present disclosure are related to generating a personalized list of items.

### BACKGROUND

With the large volume of listings of goods, services, and the like available for purchase on the Internet, a user can very easily become overwhelmed when presented with a number of listings. For example, a user may search for an item for sale and be presented with thousands of listings.

The subject matter claimed in the present disclosure is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system that may be used to present a personalized list of items to a user,

FIG. 2A illustrates an example of a first configuration of a user interface;

FIG. 2B illustrates an example of a second configuration of the user interface of FIG. 2A;

FIG. 3 illustrates an example interactive visual element;

FIG. 4 illustrates another example of an interactive visual element;

FIG. 5 includes a flowchart of an example computer-implemented method to generate a personalized list of items; and

FIG. 6 illustrates a diagrammatic representation of a machine in the example form of a computing device within which a set of instructions, for causing the machine to perform any one or more of the methods discussed herein, may be executed, each in accordance with one or more embodiments of the present disclosure.

### DESCRIPTION OF EMBODIMENTS

Some embodiments of the present disclosure may relate to generating a personalized list of items. Under conventional systems, when a user submits a query for a listing of goods or services for sale, such as tickets to an event, traditionally the user may be provided with every possible listing that meets the criteria of the search request sent by the user. However, such a query may result in an unusable or distractingly large number of results. In some instances, the results may be organized by price which may inherently assume that price is the most important attribute to the user. These techniques typically do not provide the user with items that are tailored to that user's particular preferences and may not account for other properties of the listings that the user may value.

Aspects of the present disclosure address these and other deficiencies of conventional systems by generating a personalized list of items that may be tailored to a particular user. The personalized list of items may be tailored to prioritize items that may be of high interest to a user. The personalized list of items may be generated on a per-user basis and may be customized to a single user. The personalized list of items may also be periodically generated to accommodate for changes in what types of items that user may value. In at least one embodiment, the personalized list of items may be generated based on user information, such as historical activity of the user.

In some embodiments of the present disclosure, the personalized list of items may be generated based on historical activity of other similar users. For example, a method may include receiving a search request for an event from a user via the user device. The method also may include determining a set of items pertaining to the event based on the search request. The method may further include determining an item score for each item in the set of items based at least in part on user information and a plurality of properties. The method may include generating a personalized item listing that includes at least some of the items in the set of items based on the item score of each item. The method may also include transmitting the personalized list of items to the user device for display on the user device.

By generating a personalized list of items for users, a number of benefits may be achieved. For example, users may be provided with a personalized list of items for their review and selection, increasing the likelihood of the user purchasing an item from the list.

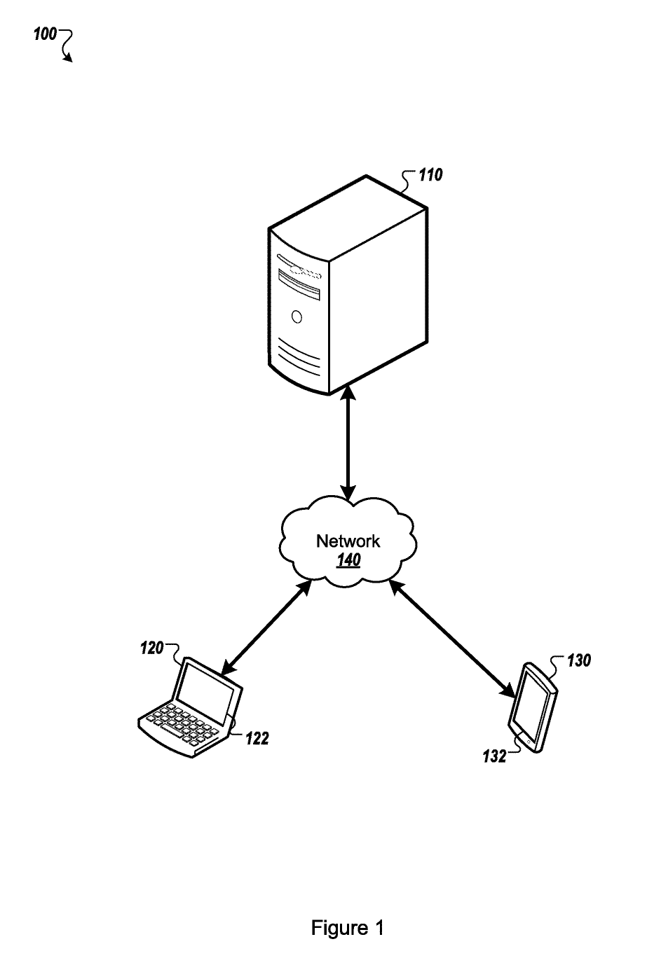

Turning to the figures, FIG. 1 illustrates an example system 100 that may be used to present a personalized list of items to a user, in accordance with one or more embodiments of the present disclosure. The system 100 may include a server 110, a first device 120 with a display 122, a second device 130 with a display 132, and a network 140.

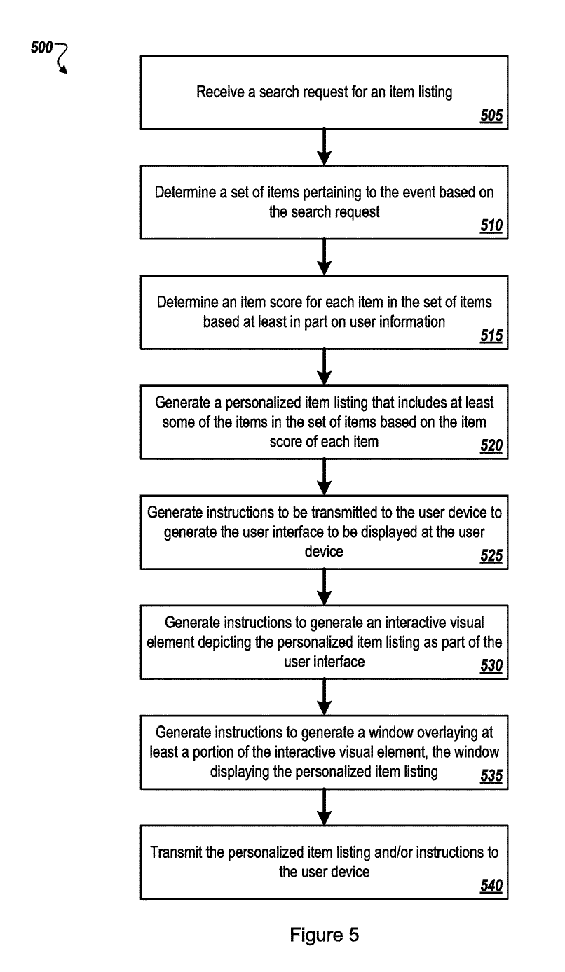

The server 110 may include any system, device, component, or combinations thereof configured to receive a search request or query regarding items and may provide results (e.g., a personalized list of items) in response. The server 110 may additionally be configured to perform one or more of the operations described in the present disclosure, such as one or more of the operations described with respect to FIG. 5. In some embodiments, the server 110 may include a processor, a memory, and a storage device. In these and other embodiments, the server 110 may operate as part of a network-based commerce system such as eBay®, StubHub®, etc. from which the server 110 may retrieve and/or process listings. The server 110 may be implemented as any device, such as a blade server, a rack server, a desktop, a laptop, a mobile device, a tablet, etc.

The first device 120 may include any system, device, component, or combinations thereof configured to allow a user to interact with the first device 120 to request listings from the server 110, and have the listings displayed to the user at the display 122. In some embodiments, the first device 120 may include a processor, a memory, and a storage device in addition to the display 122. The first device 120 may be implemented as any device, such as a blade server, a rack server, a desktop, a laptop, a mobile device, a tablet, etc. The second device 130 may be comparable or similar to the first device 120. The second device 130 may include a display 132.

The network 140 may include any device, system, component, or combination thereof configured to provide communication between one or more of the server 110, the first device 120, and the second device 130. By way of example, the network 140 may include one or more wide area networks (WANs) and/or local area networks (LANs) that enable the server 110, the first device 120, and/or the second device 130 to be in communication with each other. In some embodiments, the network 140 may include the Internet, including a global internetwork formed by logical and physical connections between multiple WANs and/or LANs. Alternately or additionally, the network 140 may include one or more cellular RF networks and/or one or more wired and/or wireless networks such as, but not limited to, 802.xx networks, Bluetooth access points, wireless access points, IP-based networks, or the like. The network 140 may also include servers that enable one type of network to interface with another type of network. Additionally or alternatively, the network 140 may include an Intranet, or one or more computing devices in communication within an organization or an in otherwise secure manner.

In operation, the first device 120 and/or the second device 130 may submit a search request or otherwise query the server 110 for listings of items (e.g., goods or services for sale). The server 110 may generate a personalized list of items in response, and may send the personalized list of items to the requesting device (e.g., the first device 120, the second device 130). The server 110 may generate instructions that direct or instruct the requesting device to generate a user interface to be displayed on the requesting device based on the search request and on information pertaining to the user who submitted the search request.

In an example, a user operating the first device 120 may request a listing of tickets for sale for an event at a given venue on a given date. The event may be a live event or a presentation of a previously recorded event. The request may be transmitted from the first device 120 over the network 140 to the server 110. The server 110 may retrieve some or all listings of tickets for the event at the given venue on the given date as a set of items.

The server 110 may determine an item score for each of the items. The item score may be determined based on various properties of each item as compared to user information. For example, to determine a first item score for a first ticket in the set of items, the server 110 may compare properties in common between the first ticket and user information, such as past activities of the user. The user information may include information pertaining to at least one previous purchase of the user. The properties may include at least one property pertaining to attending the event. Examples of such properties and user information may include date, price, location properties (e.g., venue, seat, row, close to a frequently visited restaurant, proximity to a landmark, proximity to concessions, restrooms, merchandise, exits, parking lot, other users who have attended events with the user, how much the user may typically spend, how close to event time the user typically purchases, purchased VIP-type experiences, etc.), view (e.g., obstructed, elevated, normal), event type (e.g., sporting event, concert), subject of the event (e.g., a particular band or sports team), delivery method (e.g., will-call, deliver by mail, print), quantity (e.g., two tickets, three tickets, etc.), type of seats (e.g., ADA compliant) or payment method (e.g., credit card, PayPal®, cash-on-delivery). The item score may be indicative of a determined desirability of an item to the user. The desirability of the item may be determined based on past activities of the user. For example, the past activities of the user may include browsing, searching, filtering, selecting and/or purchasing tickets. The past activities of the user may also include a previously expressed or implied interest of the user in making a purchase (e.g., adding tickets to a shopping to cart, marking a ticket or event as a favorite). For example, the item score may indicate a similarity between tickets for the event as compared to past activities of the user. In particular, the user may have purchased tickets for seats positioned behind home plate for multiple baseball games. Tickets with similar properties as those the user has previously purchased (e.g., behind home plate) may have an item score indicative of being high potential value to the user. In another example, the user may have purchased tickets for seats positioned behind home plate for multiple baseball games, which may indicate that the user may desire seats close to the field or court. As such, seats for other types of events (e.g., court side basketball games) may also have an item score indicative of being high potential value to the user. Similarly, tickets with similar properties as those that other similar users have previously purchased (e.g., behind home plate) may have an item score indicative of being high potential value to the user. For example, the server 110 may use the user information to identify other users with similar user information. The server 110 may identify purchase histories from other similar users and use those purchase histories from the other similar users when determining an item score. In an example, the user may be browsing for tickets to an event. The server 110 may identify other similar users who have purchased tickets to the event (or to a similar event). Whether or not the user has attended the event before in the past, the server 110 may increase item ranks for tickets that were previously purchased by similar users.

The server 110 may generate a personalized item listing that includes at least some of the items in the set of items based on the item score of each item. For example, a ticket with an item score indicative of being high potential value to the user (e.g., tickets for seats behind home plate), may be included in the personalized item listing. In at least one embodiment, the server 110 may rank each item to be presented with respect to their respective item scores. Items with an item score indicative of being high potential value to the user may have a higher rank than items with an item score indicative of being low potential value to the user. In at least one embodiment, the server 110 may generate the personalized item listing to include items with an item score above a score threshold. If a given item exceeds the score threshold with another listing to be displayed, the item with the lower item score may not be displayed, removed from the set of items, or otherwise excluded from being provided to the user. For example, the item with the lower item score may be transmitted to the user's device but flagged in such a way that the item with the lower item score is not displayed.

In some embodiments, the item score may be based on a single property (e.g., same seat row), multiple properties (e.g., row, price, and view), or a comparison of properties such as proximity (e.g., within fifteen feet of another seat, within three rows of the home team dugout). Items with similar properties may have similar item scores. For example, tickets within three rows of each other may have a similar item score, within ten percent of the same price may have a similar item score, and tickets with the same type of view may have a similar item score.

In some embodiments, one or more of the properties may be associated with a weighting factor. For example, a seat row property may be weighted differently than a price property such that variations in price may affect item scores more or less than a seat row property. For example, a price difference may be counted more significantly than a row difference, e.g., a first ticket on the row directly behind a second ticket with a fifteen percent price difference may have a higher item score and a third ticket two rows behind the first ticket with a fifteen percent price difference may have a similar item score, and a fourth ticket four rows behind the first ticket with a fifteen percent price difference may have a lower item score.

In another example, one or more properties of a recent purchase may be weighted higher to prioritize properties of current or recent purchases. Properties of a recent purchase may be indicative of what properties the user currently values. In another example, the server 110 may identify a frequency or count of similar properties from the user's previous purchases and add a weighting factor to one or more of the most frequent properties. For example, if a user has purchased tickets to sit near first base in a high number of baseball games, a property of “close proximity to first base” may be afforded a weighting factor such that tickets that are close in proximity to first base may have a higher item score than tickets that have similar properties but are not close in proximity to first base.

In some embodiments, some properties may have a reasonably clear superior value and may be weighted accordingly. For example, a closer row, a lower price, or a better/more clear view, etc. may be of higher value to the user. Additionally or alternatively, some properties may not have a clear superiority value, such as payment method, delivery method, etc., as such properties may represent user preference. In such instances, for properties with multiple options available (e.g., a seller accepting multiple forms of payment), the more options and/or the more commonly used option may be weighted such that they contribute to a higher item score.

In situations in which the system 100 collects personal information about users, or may make use of personal information, the users may be provided with an opportunity to control whether the server 110, first device 120, or second device 130 collects user information (e.g., information about a user's social network, social actions or activities, profession, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server 110, first device 120, or second device 130.

Modifications, additions, or omissions may be made to FIG. 1 without departing from the scope of the present disclosure. For example, the system 100 may include more or fewer elements than those illustrated and described in the present disclosure. For example, the system 100 may include any number of devices or servers. As another example, the system 100 may include multiple or alternative servers hosting listings that the server 110 may query or otherwise request results from in response to a search request received from a user.

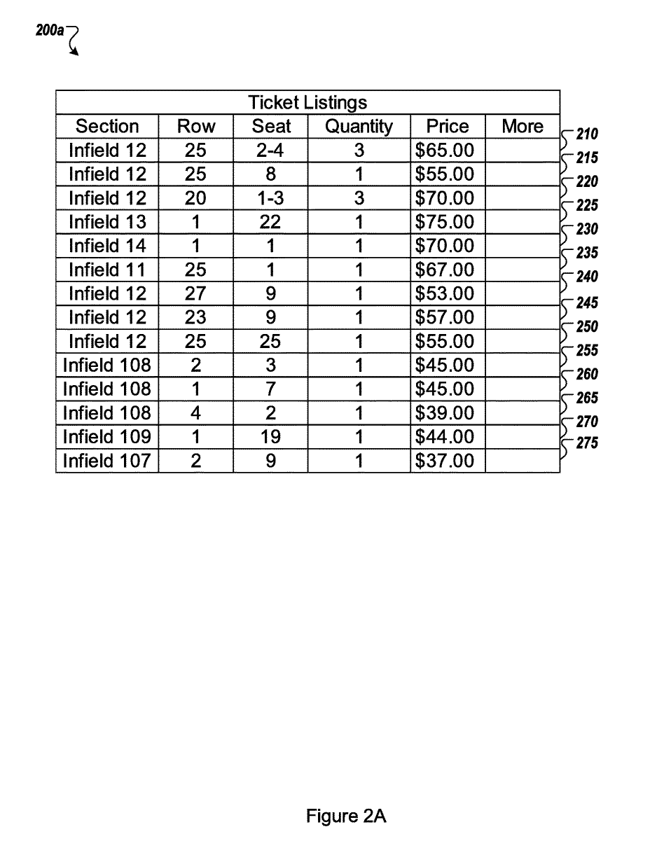

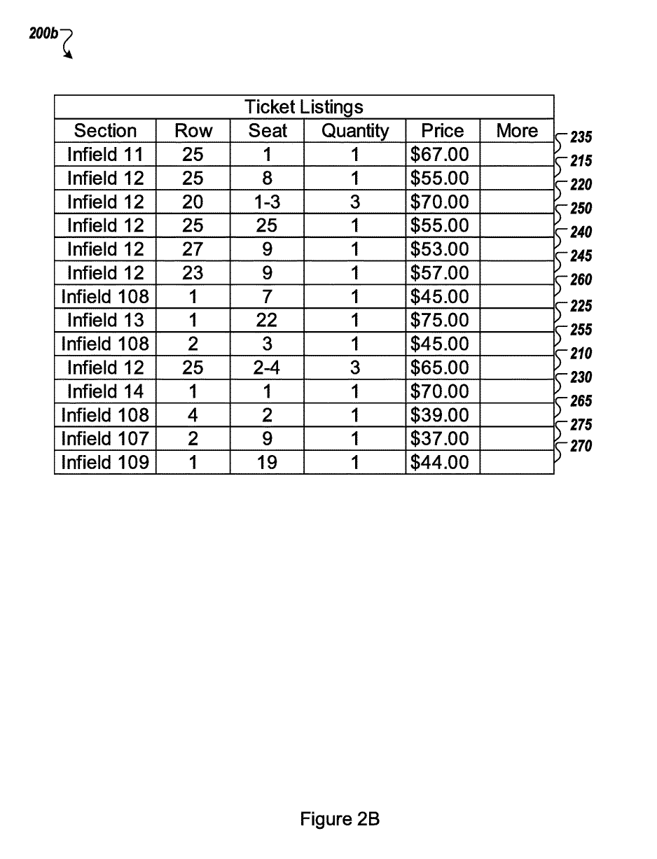

FIGS. 2A and 2B illustrate an example of a first and second configuration of a user interface 200a and 200b, in accordance with one or more embodiments of the present disclosure. FIG. 2A may illustrate a user interface 200a of presenting listings that have not been personalized based on user information, and FIG. 2B may illustrate a user interface 200b presenting listings that have been personalized based on user information in accordance with the present disclosure.

For example purposes, the user interfaces 200a and 200b illustrated in FIGS. 2A and 2B depict listings of tickets for an event in a baseball stadium. The user interfaces 200a and 200b may convey to the user one or more properties of the listings, such as “Section,” “Row,” “Seat,” “Quantity,” and “Price” as illustrated in FIGS. 2A and 2B. The user interfaces 200a and 200b also include a “More” property section to allow the display of additional properties besides those illustrated. Listings 210, 215, 220, 225, 230, 235, 240, 245, and 250 may each be for seats on a lower deck section of the baseball stadium, as indicated by the “Infield 1X” format. Listings 255, 260, 265, 270, and 275 may each be for seats on an upper deck section of the baseball stadium, as indicated by the “Infield 1XX” format.

In FIG. 2A, the user interface 200a includes a first listing 210, a second listing 215, a third listing 220, a fourth listing 225, a fifth listing 230, a sixth listing 235, a seventh listing 240, an eighth listing 245, a ninth listing 250, a tenth listing 255, an eleventh listing 260, a twelfth listing 265, a thirteenth listing 270, and a fourteenth listing 275. The user interface 200a may include any number of listings. The listings 210, 215, 220, 225, 230, 235, 240, 245, 250, 255, 260, 265, 270, 275 may be sortable by any property, such as by “Section,” “Row,” “Seat,” “Quantity,” or “Price.” Each of the listings 210, 215, 220, 225, 230, 235, 240, 245, 250, 255, 260, 265, 270, 275 may be associated with a respective item score, as described herein.

FIG. 2B illustrates the user interface 200b which includes the listings 210, 215, 220, 225, 230, 235, 240, 245, 250, 255, 260, 265, 270, 275 which have been personalized for the user according to their respective item scores. In the example embodiment, the item scores may be a numerical value and the higher the numerical value, the higher the potential value the tickets may have to a user. As illustrated, listing 235 has the highest item score and is thus displayed in a most prominent position in the list of items, listing 215 has the second highest item score, listing 220 has the third highest item score, listing 250 has the fourth highest item score, listing 240 has the fifth highest item score, listing 245 has the sixth highest item score, listing 260 has the seventh highest item score, listing 225 has the eighth highest item score, listing 255 has the ninth highest item score, listing 210 has the tenth highest item score, listing 230 has the eleventh highest item score, listing 265 has the twelfth highest item score, listing 275 has the thirteenth highest item score, and listing 270 has the fourteenth highest item score.

For purposes of the example, each of the listings may have a different item score. As discussed, the item score may indicate a potential value to the user. Thus, despite listing 215 and listing 240 being on the same row (row 25) in the same section (section Infield 12), they may not have an identical item score. The difference in item score may be based on any property, such as seat, a known obstruction that may inhibit the view of someone sitting in the seat in listing 240, user information, similar user information, etc.

In another example, while the user may typically prefer seats in a lower deck section (as determined based on the user information), the user information may also indicate that the user may prefer to view the baseball field from a particular vantage point. Listing 260 may provide a vantage point similar to a vantage point that may be of interest to the user, although listing 260 is for a seat in the upper deck section. Thus, the item score for listing 260 may be higher than the item scores for listings 210 and 230 because listings 210 and 230 may not afford the user with such a vantage point. In at least one embodiment, the items may be ordered on their items scores from the best to the worst. In at least one embodiment, the items may be sortable using various filters (e.g. price ranges, zones, sections, quantity).

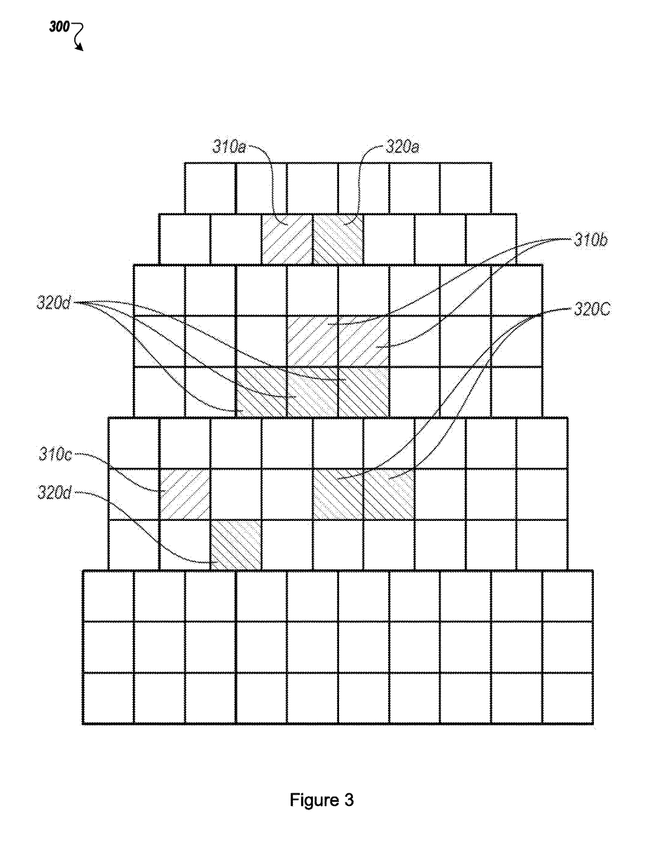

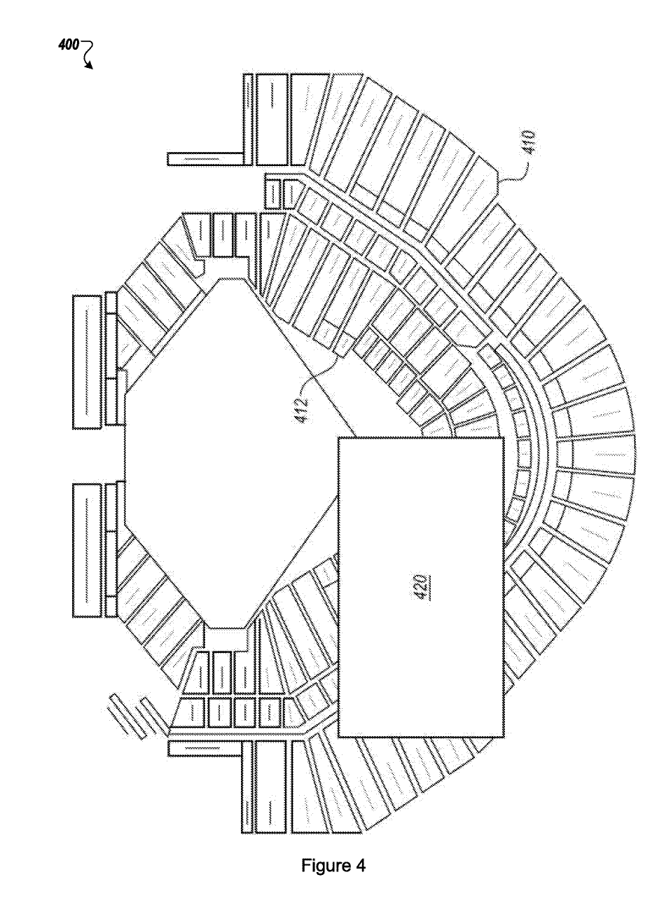

Modifications, additions, or omissions may be made to FIGS. 2A and 2B without departing from the scope of the present disclosure. For example, the user interfaces 200a and/or 200b may include more or fewer elements than those illustrated and described in the present disclosure. For example, the user interface 200a and 200b may display more or fewer properties than those illustrated. As another example, the listings may be for products or services, rather than tickets. As an additional example, the user interface 200a and/or 200b may be a portion of a larger user interface that may include an interactive visual element, such as that illustrated in FIG. 3 or 4.

FIG. 3 illustrates an example interactive visual element 300, in accordance with one or more embodiments of the present disclosure. The interactive visual element 300 may be part of a user interface provided to a user. For example, the user interface may include the user interface 200b from FIG. 2B and the interactive visual element 300 from FIG. 3.

The interactive visual element 300 may represent a visual depiction of one or more listings responsive to a search request from a user. For example, if a user selected a particular region of a venue for an event for ticket sales, the interactive visual element 300 may represent an interactive map of seats in the section (as illustrated in FIG. 3). In some embodiments, the interactive visual element 300 may display listings that are displayed to the user (listings 310) in one format while displaying other listings (listings 320) to the user in a different format. The format may be based on an item score or range of item scores. For example, the listings 310 may including listings within a first item score range and may be in a different shading, color, texture, or other visual representation to distinguish the listings 310 from the listings 320 that are within a second item score range.

In some embodiments, the listings 310 and the listings 320 may have a corresponding textual description of the listing included (for example, as illustrated in FIG. 2B). In some embodiments, seats not for sale may be depicted in a non-descript color such as white, gray, or black, or in a color to signify they are not displayed such as red, orange, or yellow.

In some embodiments, the interactive visual element 300 may be implemented using code implemented by the device of the user (e.g., the first device 120 of FIG. 1). For example, the interactive visual element 300 may be implemented using Javascript or Hypertext markup language (HTML). The device of the user may execute such user-device code. Based on the execution of the user-device code, the user may interact with the interactive visual element 300 to change a configuration of the interactive visual element 300.

For example, the interactive visual element 300 may include elements through which a user may interact with the interactive visual element 300. The user-device code executed by the device of the user may obtain the user interactions and change the configuration of the interactive visual element 300 accordingly. For example, the configuration of the interactive visual element 300 may change by changing the section of the venue displayed in the map. Alternately or additionally, the user-device code may request additional data from a server (e.g., the server 110 of FIG. 1), such as images, listings, or other information. In at least one embodiment, the user may provide input to change or alter a presentation of listings. The input may be provided by the user through a graphical user interface tool, such as providing text to a text field, a selection of an item in a drop down box, or a selection (or deselection) of a check box, etc. For example, the user may provide input to exclude listings in an upper deck of a stadium. In another example, the user may provide an input to control a number of listings that are shown (e.g., one, three, six, etc.).

Modifications, additions, or omissions may be made to FIG. 3 without departing from the scope of the present disclosure. For example, the interactive visual element 300 may include more or fewer elements than those illustrated and described in the present disclosure. For example, the interactive visual element 300 may be part of a user interface that includes a textual description of included listings.

FIG. 4 illustrates another example of an interactive visual element 400, in accordance with one or more embodiments of the present disclosure. The interactive visual element 400 may include a venue map 410 with one more sections (e.g., section 412) depicting a venue with listings of seats for purchase. The interactive visual element 400 may additionally include a window 420 for displaying listings.

The interactive visual element 400 may be configured such that a user displaying the interactive visual element 400 may select one or more features of the interactive visual element 400 to interact with the user interface. Interacting with the user interface may allow the user to perform a query, refine a query, examine a listing, etc. For example, if a user were to click on the section 412 of the venue map 410, the window 420 may display a textual description of listings in that section, such as that depicted by the user interface 200b of FIG. 2B.

In some embodiments, the window 420 may be sized and/or positioned to overlay portions of the venue map 410, for example, as illustrated in FIG. 4. In these and other embodiments, the window 420 may be sized and/or positioned based on the display properties of the display of the device used by the user. For displays with lower resolution and/or smaller display areas, the window 420 may overlay a larger portion of the venue map 410. For displays with high resolution and/or larger display areas, the window 420 may overlay a smaller portion of the venue map 410.

In some embodiments, the display of listings in the window 420 may include listings sorted according to respective item scores in accordance with the present disclosure. For example, if the user selected the section 412, the window 420 may include listings from section 412 and/or from nearby sections that are sorted according to their respective item scores.

By selecting a section of the venue map 410, in some embodiments the interactive visual element 400 may display the venue map 410 replaced with a map of the selected section. For example, the interactive visual element 400 may include a map of a section as illustrated in FIG. 3 rather than the entire venue map 410 as illustrated in FIG. 4. In these and other embodiments, the window 420 may overlay a portion of the map of the section.

In some embodiments, the venue map 410 may be formatted in a similar manner to that described with reference to FIG. 3. For example, portions of the venue map 410 may be formatted a first way for a first group of seats included in the window 420, and a second way for a second group of listings. In some embodiments, the seats in the window 420 may be formatted in the same manner as the rest of the venue map 410.

Modifications, additions, or omissions may be made to FIG. 4 without departing from the scope of the present disclosure. For example, the interactive visual element 400 may include more or fewer elements than those illustrated and described in the present disclosure. For example, the interactive visual element 400 may include additional features, links, or aspects of interacting with the interactive visual element 400 not illustrated.

FIG. 5 includes a flowchart of an example computer-implemented method 500 to generate a personalized list of items. The method 500 may be performed by any suitable system, apparatus, or device. For example, the system 100 of FIG. 1 may perform one or more of the operations associated with the method 500. The method 500 may be performed by processing logic that may include hardware (circuitry, dedicated logic, etc.), software (such as is run on a general purpose computer system or a dedicated machine), or a combination of both. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

Turning to FIG. 5, at block 505, processing logic may receive a search request for an event. For example, a user may submit a request via a device (e.g., the first device 120 or the second device 130 of FIG. 1) to a server (e.g., the server 110 of FIG. 1) to be provided with listings, such as items for sale, tickets for sale, etc. In some embodiments, such a request may be submitted by the user interacting with an interactive visual element (e.g., selecting a section of a venue map).

At block 510, the processing logic may determine a set of items pertaining to the event based on the search request. For example, when the search request is for a baseball game on a particular date or for one or more baseball teams, the processing logic may retrieve tickets for the event from a data storage. For example, a server may recall the set of items from a storage device of the server housing a network-based commerce system, or may request and receive the listings from another computer system.

At block 515, the processing logic may determine an item score for each item in the set of items based at least in part on user information and item properties, as described above. The user information may include activities of the user, such as past purchases or other activities related to various similar activities. For example, the user information may include historical data that includes properties of tickets to baseball games that the user has previously purchased. The properties in the historical data may include any information pertaining to the event and/or the tickets, as described herein. The processing logic may use the user information to determine the item score for each item in the set of items.

In at least one embodiment, to determine the item score for each item in the set of items, the processing logic may determine a quality score for a first item. The quality score may be a numerical representation of an objective quality of a given item. For example, a ticket may be a high quality item if the ticket is for an objectively “good” seat, such as a seat with a view of most of a sports field. Similarly, a ticket may be a lower quality item if the ticket is for a seat with an obstructed view of a sports field. In at least one embodiment, a group of items may have the same or similar quality score. For example, each seat in the same section on the same row may have a same quality score. In at least one embodiment, the quality score for the same item (e.g., the same seat in a stadium) may be affected by a type of event or configuration of the event location. For example, a seat in a soccer game may have a different quality score than the same seat at a rock concert.

In at least one embodiment, the processing logic may determine the item score in view of the quality score of an asking price of the item. In these embodiments, the item score may be a trade-off between how good a seat is (e.g., the seat quality) and the price a seller is asking for the given item. The processing logic may determine the item score, for example, by adding, subtracting, multiplying, dividing, or by performing another mathematical operation on the quality score and the asking price. The result may include the item score. The higher the item score, the better deal an item may be as compared to other items available at the same time for the same event.

At block 520, the processing logic may generate a personalized item listing that includes at least some of the items in the set of items based on the item score of each item. The processing logic, for example, may rank each item in the set of items based on their respective item scores (which may also indicate potential value to the user). The processing logic may generate the personalized item listing to feature the items according to their rank such that those items that are potentially of high value to the user are more prominently presented in the personalized item listing. The processing logic may also generate the personalized item listing to include items with an item score above a score threshold value. In some embodiments, a weighting factor may be used in determining the item scores.

At block 525, the processing logic may generate instructions configured to instruct the user device to generate the user interface displayed on the user device. Such a user interface may include the personalized item listing. Each item in the personalized item listing may be presented based on the respective item score for each item.

At block 530, the processing logic may generate instructions to generate an interactive visual element depicting the personalized item listing as part of the user interface. For example, a venue map or section map with which a user may interact may be part of the user interface.

At block 535, the processing logic may generate instructions to generate a window overlaying at least a portion of the interactive visual element. The window may display the personalized item listing.

At block 540, the processing logic may transmit the personalized item listing and/or the instructions generated at any of blocks 525, 530, 535 to the remote location, such as to the user device.

Modifications, additions, or omissions may be made to the method 500 without departing from the scope of the present disclosure. For example, any of the blocks 530 and/or 535 may be omitted. As another example, the operations of the method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

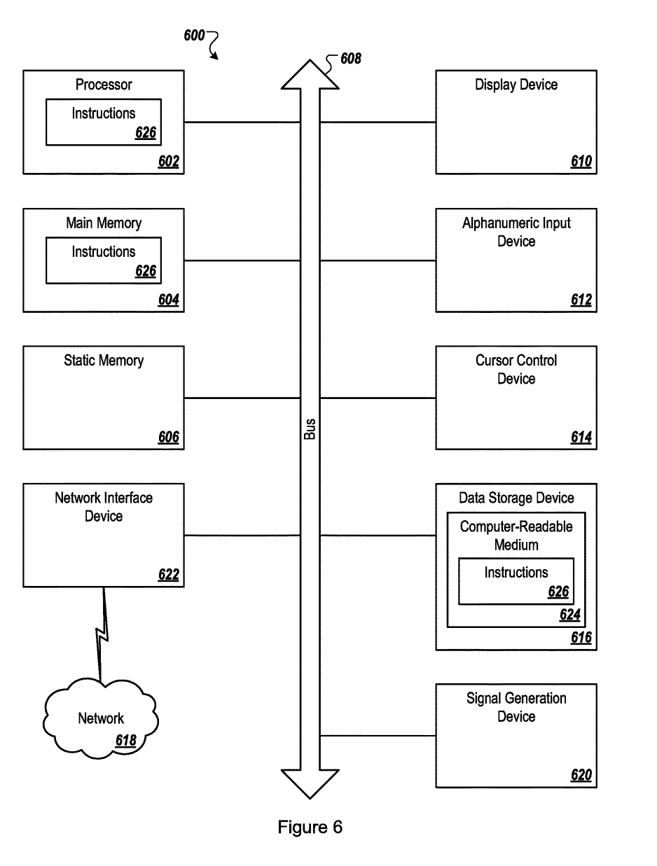

FIG. 6 illustrates a diagrammatic representation of a machine in the example form of a computing device 600 within which a set of instructions, for causing the machine to perform any one or more of the methods discussed herein, may be executed. The computing device 600 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed in the present disclosure.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In one implementation, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 626 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of the following: A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it may be understood that the various changes, substitutions, and alterations may be made hereto without departing from the spirit and scope of the present disclosure.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

1. A method to generate a user interface to be displayed at a user device, the method comprising:
receiving a search request for an event from a user via a user device;
determining a set of items pertaining to the event based on the search request;
determining an item score for each item in the set of items based at least in part on user information and a plurality of properties of the event, wherein the user information includes information pertaining to at least one previous purchase of the user, and wherein the plurality of properties of the event includes at least one property pertaining to attending the event, wherein determining the item score for each item in the set of items comprises:
identifying the user information in an electronic database; and
comparing the user information with at least one of the plurality of properties of the event to determine a similarity between the user information and the at least one of the plurality of properties of the event, wherein the item score is determined based on the similarity between the user information and the at least one of the plurality of properties of the event;
generating a personalized electronic item listing that includes at least some of the items in the set of items based on the item score of each item;
generating instructions configured to instruct the user device to generate a user interface displayed on the user device, the user interface including the personalized electronic item listing, wherein each item in the personalized electronic item listing is to be presented in the user interface based on the respective item score for each item; and
transmitting the instructions to the user device.

2. The method of claim 1, wherein determining the item score for each item in the set of items comprises determining a quality score for each item in the set of items, wherein the quality score is a numerical representation of an quality of a given item, wherein the quality of the given item is indicative of a general desirability of the item to a set of users, wherein the item score is determined based on the quality score and the similarity between the user information and the at least one of the plurality of properties of the event.

3. The method of claim 1, wherein the user information includes past activity of the user or one or more similar users with respect to purchasing the item or a similar item.

4. The method of claim 1, wherein generating the personalized electronic item listing that includes at least some of the items in the set of items based on the item score of each item comprises determining a rank for each item to be included in the personalized electronic item listing, wherein each item to be included in the personalized electronic item listing is to be presented according to the respective rank.

5. The method of claim 1, further comprising:
generating an interactive visual element depicting the personalized electronic item listing as part of the user interface; and
generating a window overlaying at least a portion of the interactive visual element, the window displaying the personalized electronic item listing.

6. The method of claim 1, wherein the plurality of properties of the event include at least two of the following: date, price, seat, row, section, proximity to a landmark, view, delivery method, or payment method.

7. The method of claim 1, wherein at least one item score is determined using a weighting factor for at least one of the plurality of properties of the event.

8. A non-transitory computer-readable medium including instructions that, when executed by a processor, are configured to control operations, the operations comprising:
receiving a search request for an event from a user via a user device;
determining a set of items pertaining to the event based on the search request;
determining an item score for each item in the set of items based at least in part on user information and a plurality of properties of the event, wherein the user information includes information pertaining to at least one previous purchase of the user, and wherein the plurality of properties of the event includes at least one property pertaining to attending the event, wherein determining the item score for each item in the set of items comprises:
identifying the user information in an electronic database; and
comparing the user information with at least one of the plurality of properties of the event to determine a similarity between the user information and the at least one of the plurality of properties of the event, wherein the item score is determined based on the similarity between the user information and the at least one of the plurality of properties of the event;
generating a personalized electronic item listing that includes at least some of the items in the set of items based on the item score of each item; and
transmitting the personalized electronic item listing to the user device.

9. The non-transitory computer-readable medium of claim 8, wherein determining the item score for each item in the set of items comprises determining an quality score for each item in the set of items, wherein a quality of a given item is indicative of a general desirability of the given item to a set of users, wherein the quality score is a numerical representation of the quality of the given item, wherein the item score is at least partially determined based on the quality score and the similarity between the user information and the at least one of the plurality of properties of the event.

10. The non-transitory computer-readable medium of claim 8, wherein the user information includes past activity of the user or one or more similar users with respect to purchasing the item or a similar item.

11. The non-transitory computer-readable medium of claim 8, wherein generating the personalized electronic item listing that includes at least some of the items in the set of items based on the item score of each item comprises determining a rank for each item to be included in the personalized electronic item listing, wherein each item to be included in the personalized electronic item listing is to be presented according to the respective rank.

12. The non-transitory computer-readable medium of claim 8, wherein the instructions further instruct the processor to control further operations, the further operations comprising:
generate an interactive visual element depicting the personalized electronic item listing as part of a user interface; and
generate a window overlaying at least a portion of the interactive visual element, the window displaying the personalized electronic item listing.

13. The non-transitory computer-readable medium of claim 8, wherein the plurality of properties of the event include at least two of: date, price, seat, row, section, proximity to a landmark, view, delivery method, or payment method.

14. The non-transitory computer-readable medium of claim 8, wherein at least one item score is determined using a weighting factor for at least one of the plurality of properties of the event.

15. A system comprising:
a memory, and
a processor operatively coupled to the memory, the processor being capable to execute computer-readable instructions that, when executed by the processor, cause the processor to:
receive a search request for an event from a user via a user device;
determine a set of items pertaining to the event based on the search request;
determine an item score for each item in the set of items based at least in part on user information and a plurality of properties of the event, wherein the user information includes information pertaining to at least one previous purchase of the user, and wherein the plurality of properties of the event includes at least one property pertaining to attending the event, wherein when determining the item score for each item in the set of items, the processor is configured to:
identify the user information in an electronic database; and
compare the user information with at least one of the plurality of properties of the event to determine a similarity between the user information and the at least one of the plurality of properties of the event, wherein the item score is determined based on the similarity between the user information and the at least one of the plurality of properties of the event;
generate a personalized electronic item listing that includes at least some of the items in the set of items based on the item score of each item; and
transmit the personalized electronic item listing to the user device.

16. The system of claim 15, wherein when determining the item score for each item in the set of items, the processor is configured to determine a quality score for each item in the set of items, wherein the quality score is a numerical representation of a quality of a given item, wherein the item score is at least partially determined based on the quality score and the similarity between the user information and the at least one of the plurality of properties of the event.

17. The system of claim 15, wherein the user information includes past activity of the user or one or more similar users with respect to purchasing the item or a similar item.

18. The system of claim 15, wherein when generating the personalized electronic item listing that includes at least some of the items in the set of items based on the item score of each item, the processor is configured to determine a rank for each item to be included in the personalized electronic item listing, wherein each item to be included in the personalized electronic item listing is to be presented according to the respective rank.

19. The system of claim 15, wherein the instructions further cause the processor to:
generate an interactive visual element depicting the personalized electronic item listing as part of a user interface; and
generate a window overlaying at least a portion of the interactive visual element, the window displaying the personalized electronic item listing.

20. The system of claim 15, wherein the plurality of properties of the event include at least two of: date, price, seat, row, section, proximity to a landmark, view, delivery method, or payment method.
